(19) United States
(12) Patent Application Publication
(10) Pub. No.: US 2004/0164196 A1
(43) Pub. Date: Aug. 26, 2004

(54) Taking-up device for winding a web around a core

(75) Inventor: Susumu Sato, Saitama-Shi (JP)

Correspondence Address: YOUNG & THOMPSON, 745 SOUTH 23RD STREET 2ND FLOOR, ARLINGTON, VA, 22202

(73) Assignee: FUJI PHOTO OPTICAL CO., LTD, SAITAMA-SHI (JP)

(21) Appl. No.: 10/782,789

(22) Filed: Feb. 23, 2004

(30) Foreign Application Priority Data
Feb. 25, 2003 (JP) 2003-047692

(51) Int. Cl. G11B 15/66

(52) U.S. Cl. 242/332.7

(57) ABSTRACT

A nip roller is provided to interpose a leading portion of a photo film between the nip roller and a core. The nip roller performs a circular motion along the periphery of the core in synchronism with the rotation of the core. The circular motion is performed by first to third motors until the leading portion of the photo film makes one revolution around the core and is just about to be wound in a stack condition. A conveyance slip is hardly caused between the photo film and the core, and between the photo film and the nip roller.

### BACKGROUND OF THE INVENTION

1. Field of the Invention

The present invention relates to a taking-up device for winding a web around a core.

2. Description of the Related Art

In a known photographic printer, an image exposed on a photo film is printed on a strip of a photographic paper drawn out of a magazine. This kind of the photographic printer is provided with a taking-up device, which takes up the respective strips of the photo film and the photographic paper after printing in order to proceed to the next step of checking, cutting, developing and so forth.

In a conventional way, when a web of the photo film or the photographic paper is taken up around a core, a leading portion of the web is wound around the core by an operator. However, for the purpose of further saving the labor, is proposed an automatic taking-up device provided with a guide plate for guiding the leading portion of the web to the core (see Japanese Patent Laid-Open Publication Nos. 2-106731 and 5-265100).

In devices described in the above Publications, the web is scratched in a first rotation thereof during which the leading portion is wound on the core, unless a rotational speed of the core perfectly synchronizes with a pushing speed of the leading portion. The scratch of the web is caused due to friction against the core and due to friction with each other. Moreover, since a guide plate has a curving shape, the web contacts with the guide plate so that a scratch is likely to be caused thereby. Consequently, in the case the web is the photographic paper, a certain amount thereof corresponding to the first rotation must be put into the discard as a paper loss. In the case the web is the photo film, it is necessary to attach a dummy film (leaderfilm) , which is a consumption article, to the top of the photo film.

### SUMMARY OF THE INVENTION

In view of the foregoing, it is a primary object of the present invention to provide a taking-up device in which a web is prevented from being damaged.

In order to achieve the above and other objects, the taking-up device for winding the web around a core comprises a press member to interpose a leading portion of the web between the press member and the core. The press member performs a circular motion along the periphery of the core in synchronism with a rotation of the core until the leading portion of the web makes one revolution around the core and is just about to be wound in a stack condition. By the way, the web is a photo film or a photographic paper, and the taking-up device is incorporated in a film scanner or in a photographic printer to take up the photo film or the photographic paper.

In a preferred embodiment, a nip roller is used as the press member. A revolving mechanism for the nip roller is provided to perform the above-mentioned circular motion. The revolving mechanism is a foldable arm coaxially disposed relative to the core. Further, it is preferable to provide a retracting member, which retracts the press member from the web after the leading portion of the web has made one revolution around the core and has been wound in the stack condition.

According to the taking-up device of the present invention, the leading portion of the web is interposed between the press member and the core, and in this state, the press member performs the circular motion along the periphery of the core in synchronism with the rotation of the core. Thus, the web is prevented from being damaged.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a photographic printer according to the present invention;

FIG. 2 is a perspective view showing a structure of a film guide;

FIG. 3A is a sectional view showing a guide position of the film guide;

FIG. 3B is a sectional view showing an evacuation position of the film guide;

FIG. 4 is a perspective view showing a structure of a film taking-up device;

FIG. 5 is a sectional view showing a structure of the film taking-up device;

FIG. 6 is an exploded perspective view showing a structure of a supporting point shaft and the periphery thereof;

FIG. 7A is an explanatory illustration showing a state in that a leading portion of a photo film is interposed between a nip roller and a core;

FIG. 7B is an explanatory illustration showing a state in that the leading portion of the photo film is wound around the core;

FIG. 7C is an explanatory illustration showing a state, which is set just before the leading portion of the photo film is put inside the photo film of a one-rotation delay;

FIG. 8A is an explanatory illustration showing a state in that the nip roller is evacuated;

FIG. 8B is an explanatory illustration showing a state in that a winding of the photo film has the maximum diameter; and

FIG. 9 is an illustration showing another embodiment of the present invention.

### DETAILED DESCRIPTION OF THE PREFERRED EMBODIMENT(S)

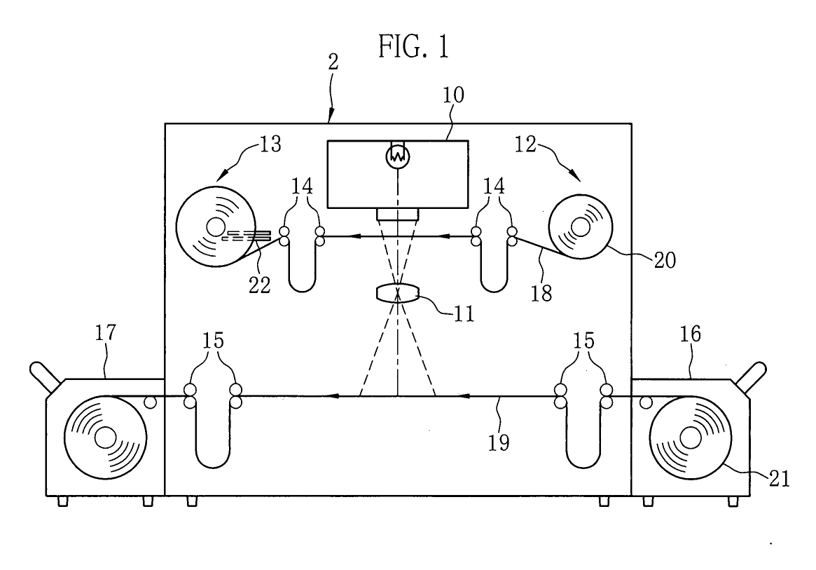

In FIG. 1, a photographic printer 2 according to the present invention is constituted of a light source 10, an image-forming lens 11, a film supply device 12, a film taking-up device 13, film feeding rollers 14, and paper feeding rollers 15. A paper supplying magazine 16 and a paper taking-up magazine 17 are attached to the photographic printer 2. Rays emitted from the light source 10 enter the image-forming lens 11 through an exposed photo film 18 advanced by the film feeding roller 14. After entering the image-forming lens 11, the rays are applied to a photographic paper 19 advanced by the paper feeding roller 15. In this way, an image recorded on the photo film 18 is printed on the photographic paper 19.

The film supply device 12 is loaded with a film roll 20 in which the photo films of several tens to several hundreds are joined with splice tapes. The paper supplying magazine 16 is loaded with an unexposed photographic paper roll 21. The photo film 18 is drawn out of the film supply device 12 and is taken up in the film taking-up device 13 so as to have a roll form again. The photographic paper 19 is drawn out of the paper supplying magazine 16 and is taken up in the paper taking-up magazine 17 so as to have a roll form again.

The photo film 18 taken up in the roll form is manually removed from the film taking-up device 13 and is carried to the next step (of checking, cutting and so forth). Incidentally, the paper supplying magazine 16 and the paper taking-up magazine 17 are detached from the photographic printer 2 when the photographic paper 19 is changed and when the photographic paper 19 taken up in the roll form is carried to the next step.

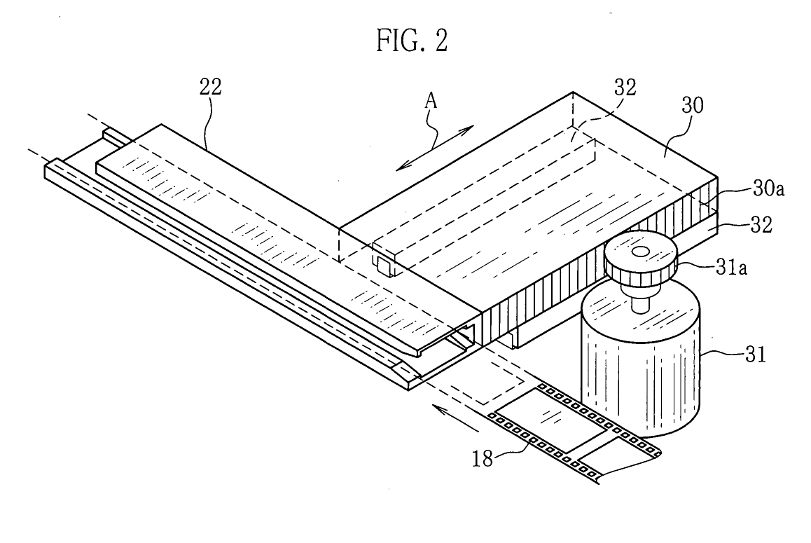

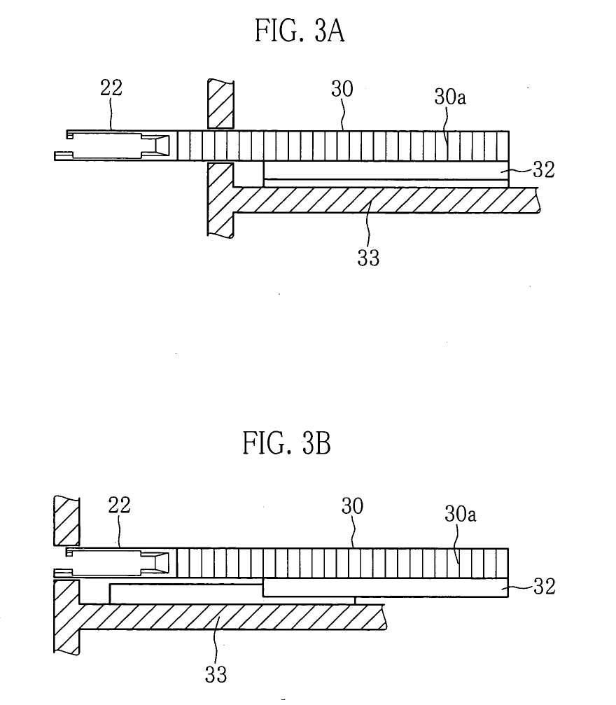

A film guide 22 for guiding the photo film 18 is disposed near the film taking-up device 13. As shown in FIG. 2, a rack 30 is attached to the film guide 22. A side of the rack 30 is formed with a rack gear 30a for meshing with a pinion gear 31a of a guide retracting motor 31. Further, a pair of rails 32 is attached to a bottom surface of the rack 30. In virtue of the rails 32, the rack 30 is reciprocated by means of the motor 31 in a direction shown by an arrow A in the drawing. Consequently, the film guide 22 is slidably supported on a body base 33 of the photographic printer 2 between a guide position and an evacuation position. The guide position is shown in FIG. 3A and the evacuation position is shown in FIG. 3B.

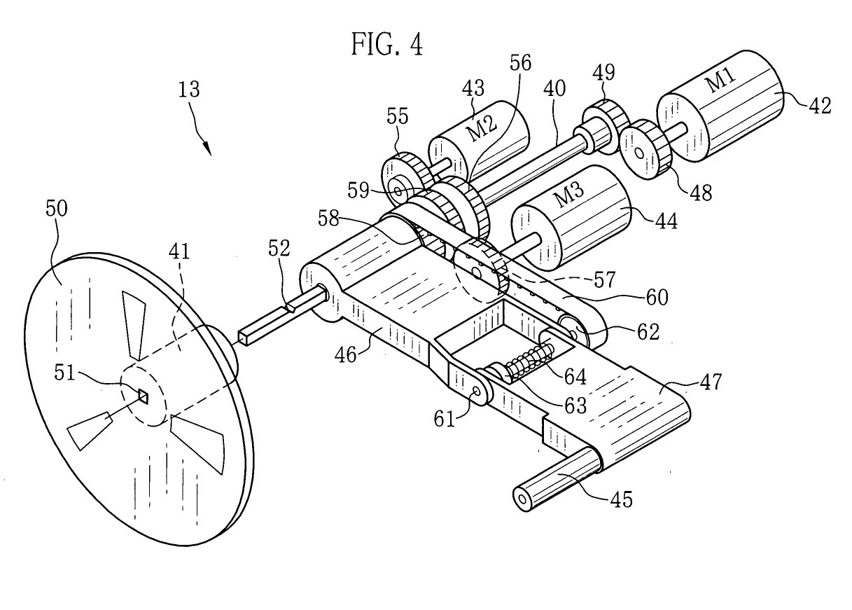

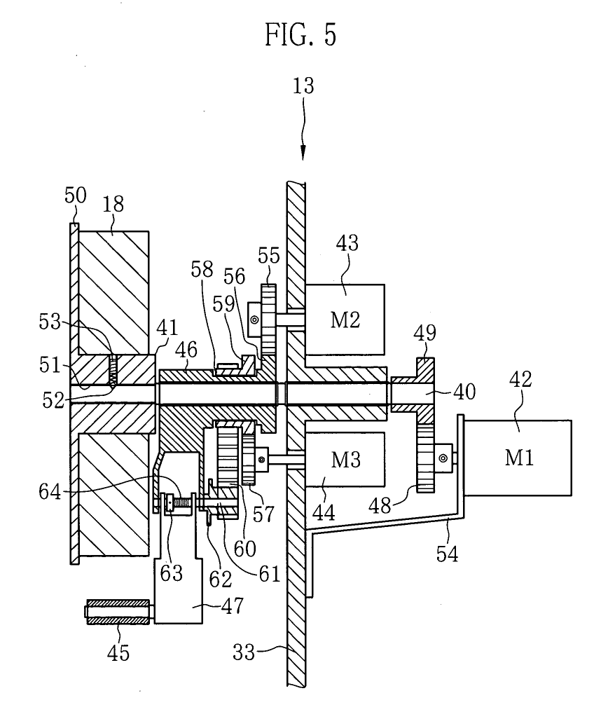

As shown in FIGS. 4 and 5, the film taking-up device 13 is constituted of a take-up shaft 40, a core 41, first to third motors (M1 to M3) 42 to 44, a nip roller 45, first and second arms 46 and 47, and so forth. A gear 49 for meshing with a gear 48 of the first motor 42 is fixed to an end portion of the take-up shaft 40. A driving force of the first motor 42 is transmitted to the take-up shaft 40, which is supported by the body base 33, via the gears 48 and 49.

The core 41 is integrally formed with a transparent reel disk 50, and the center thereof is provided with an attachment hole 51. The core 41 is fixed to the take-up shaft 40 such that the top of the take-up shaft 40 is inserted into the attachment hole 51 and a ball plunger 53 is fitted to an attachment groove 52 formed at a top portion of the take-up shaft 40.

As shown in FIG. 5, the first motor 42 is supported by a motor bracket 54 fixed to the body base 33. The second and third motors 43 and 44 are directly fixed to the body base 33. A gear 55 of the second motor 43 meshes with a gear 56 integrally formed with the first arm 46. A driving force of the second motor 43 is transmitted to first arm 46 via the gears 55 and 56.

The gear 57 of the third motor 44 meshes with a gear 59 integrally formed with a pulley 58. The pulley 58 and the gear 59 are rotatably supported by the first arm 46. A timing belt 60 is set to the pulley 58. The timing belt 60 is also set to another pulley 62 fixed to a supporting point shaft 61, which rotatably supports the second arm 47 relative to the first arm 46. A driving force of the third motor 44 is transmitted to the second arm 47 via the gears 57 and 59, the pulleys 58 and 62, the timing belt 60, and the supporting point shaft 61.

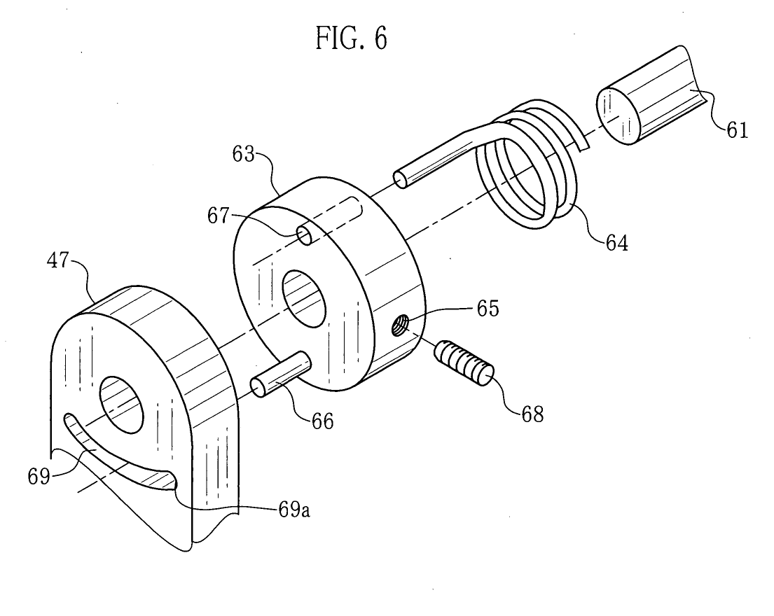

The supporting point shaft 61 is linked to the first and second arms 46 and 47. At the same time, the supporting point shaft 61 is inserted into a ring 63 and a torsion coil spring 64. As shown in FIG. 6, the ring 63 is provided with a screw hole 65, a pin 66 and a spring fixation hole 67. The ring 63 is fixed to the supporting point shaft 61 by fastening a setscrew 68 to the screw hole 65. The pin 66 is inserted into a guide hole 69 formed in one bearing of the second arm 47. One end of the torsion coil spring 64 is inserted into the spring fixation hole 67. The other end of the torsion coil spring 64 is inserted into a fixation hole, which is not shown and is formed in the other bearing of the second arm 47. The supporting point shaft 61 is urged by the torsion coil spring 64 so as to position the pin 66 at a right end 69a of the guide hole 69 in the state shown in FIGS. 4 and 5.

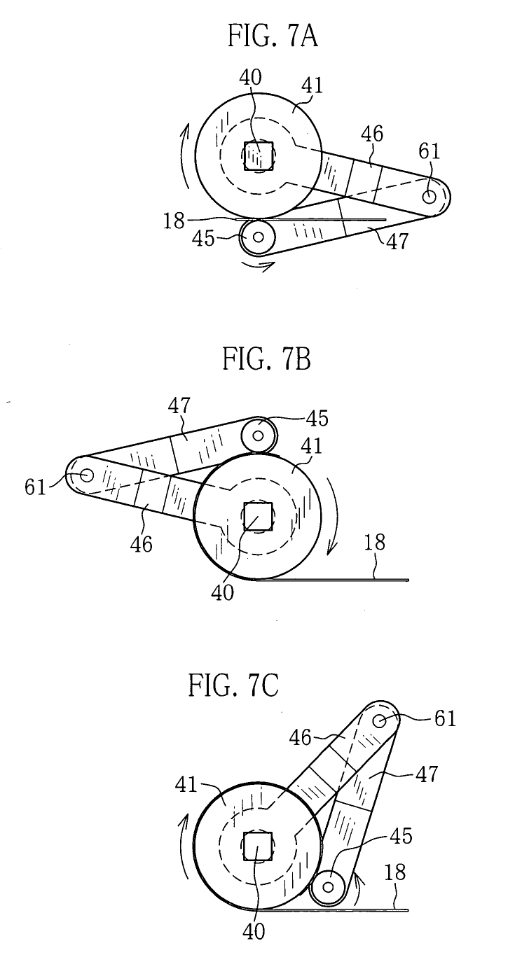

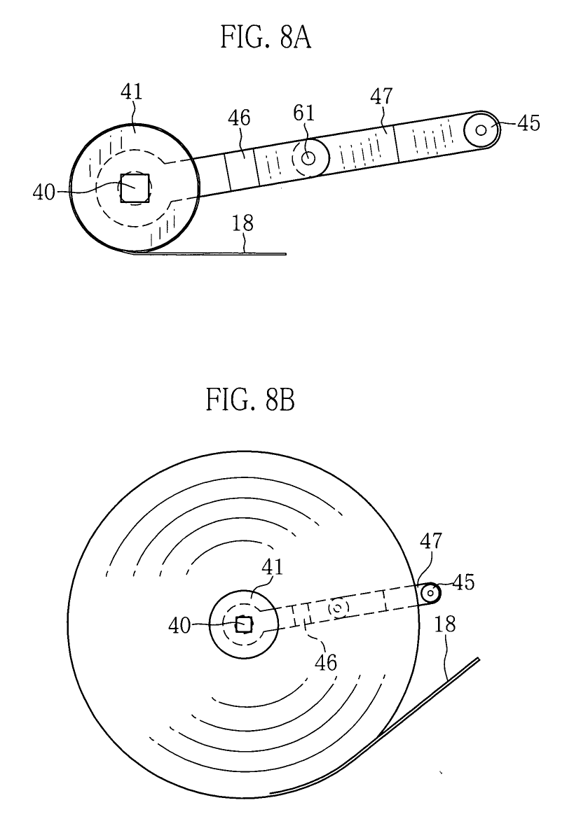

The first and second arms 46 and 47 are formed so as to make a length thereof, which extends from the center of the take-up shaft 40 in a straight state shown in FIGS. 4 and 5, longer than a maximum winding diameter of the photo film 18 including the core 41. The first and second arms 46 and 47 are rotated by means of the second and third motors between an interposing state (see FIGS. 7A to 7C) and an evacuation state shown in FIGS. 4 and 5 (also see FIGS. 8A and 8B). In the interposing state, the leading portion of the photo film 18 is interposed between the nip roller 45 and the core 41.

Referring to FIGS. 7 and 8, is described an operation in which the photo film 18 is taken up by the film taking-up device 13 having the above structure. First of all, the guide retracting motor 31 is driven to move the film guide 22 to the guide position shown in FIG. 3A. And then, the leading portion of the photo film 18 is brought to the vicinity of the core 41 by the film feeding roller 14.

Successively, the second and third motors 43 and 44 are driven to rotate the first and second arms 46 and 47 to the position shown in FIG. 7A. At the same time, the first motor 42 is driven to rotate the core 41 via the take-up shaft 40 in a clockwise direction. In association with the rotation of the core 41, the nip roller 45 is rotated to interpose the leading portion of the photo film 18, which is guided by the film guide 22, between the nip roller 45 and the core 41. At this time, owing to the rotation of the supporting point shaft 61, the torsion coil spring 64 urges the nip roller 45 via the second arm 47 toward the core 41.

After temporarily stopping the first motor 42 in the state shown in FIG. 7A, the first to third motors 42 to 44 are driven so as to make the nip roller 45 perform a circular motion along the periphery of the core 41 in synchronism with the rotation of the core 41. In virtue of this, the leading portion of the photo film 18 is wound around the core 41 such as shown in FIG. 7B. At this time, the first to third motors 42 to 44 are synchronously driven to wind the photo film 18 around the core 41 in the state that the photo film 18 is interposed between the core 41 and the nip roller 45. Thus, a conveyance slip of the photo film 18 is hardly caused between the core 41 and the nip roller 45.

The leading portion of the photo film 18 is further wound around the core 41 from the state shown in FIG. 7B. At the time of the state shown in FIG. 7C, wherein the leading portion of the photo film 18 makes one revolution around the core 41 and is just about to be wound in a stack condition, driving the second and third motors 43 and 44 is stopped and only the first motor 42 is driven to rotate the nip roller 45 in association with the rotation of the core 41. In this way, the leading portion of the photo film 18 is tucked inside the photo film 18 of one-rotation delay.

After tucking the leading portion of the photo film 18 inside the photo film 18 of one-rotation delay, the third motor 44 is reversed, driving the first motor 42 successively, to evacuate the second arm 47 to a position shown in FIG. 8A for the purpose of preventing the photo film 18 from being hindered.

Driving the first motor 42 is stopped in a state shown in FIG. 8B, wherein a winding diameter becomes the maximum diameter, and the photo film 18 wound in the roll form is taken out together with the core 41. After removing the photo film 18, the new core is attached to the take-up shaft 40. And then, the first to third motors 42 to 44 are reversed to return the first and second arms 46 and 47 from the evacuation state shown in FIG. 8A to the interposing state shown in FIG. 7A.

During the operations of FIG. 7B to FIG. 8A, the film guide 22 is moved to the evacuation position shown in FIG. 3B by means of the guide retracting motor 31. After replacing the core with the new one, the film guide 22 is returned to the guide position shown in FIG. 3A when the first and second arms 46 and 47 are returned to the state shown in FIG. 7A. By doing so, the photo film 18 and the film guide 22 are prevented from contacting with each other so that the photo film 18 is prevented from being damaged. Accordingly, it is unnecessary to join a leader film to the leading portion of the photo film so that productive efficiency may be improved. Incidentally, when the leader film is used in order to protect the photo film 18 of a roll form, a lifetime of the leader film may be elongated.

In the above embodiment, the present invention is applied to the film taking-up device 13 for winding the photo film 18. However, the paper taking-up magazine 17 for winding the photographic paper 19 may be provided with a structure similar to the film taking-up device 13. In this case, it is prevented that a certain amount corresponding to a first rotation, during which a leading portion of the photographic paper winds around a core, is put into the discard as a paper loss. Thus, running costs of the apparatus maybe lowered. Incidentally, with respect to the web to be taken up, the photo film and the photographic paper are not exclusive.

The above embodiment relates to the photographic printer 2 to be used in a large photo finishing laboratory. The present invention, however, may be applied to a “minilab” to be settled in a street DPE shop or the like. In this case, if the present invention is applied to an apparatus in which one strip of the photo film is temporarily contained after exposure or during readout of images, the mechanism for evacuating the nip roller after winding the leading portion may be removed. This is because that a change of a diameter is about 1 mm on condition a core of φ100 mm is used and a length of one photo film is about 1.5 m.

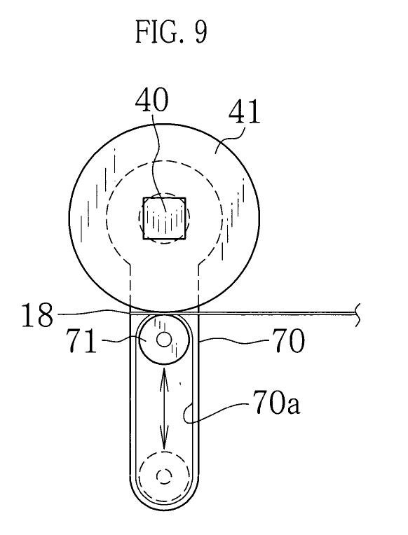

The driving mechanism for the nip roller 45 is not restricted to the first and second arms 46 and 47, the first to third motors 42 to 44, the torsion coil spring 64 and so forth described in the above embodiment. The driving mechanism for the nip roller may be properly modified in accordance with specifications of the apparatus. For example, such as shown in FIG. 9, a nip roller 71 may be moved between an interposing position, which is shown by a solid line, and a release position, which is shown by a broken line, along an elliptic hole 70a formed in one arm 70. Further, the driving mechanism for the film guide 22 is not restricted to the above embodiment. This driving mechanism may be a simple mechanism utilizing an urging force of a spring.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A taking-up device for winding a web around a core, said taking-up device comprising:
a press member for pressing a leading portion of said web against a peripheral surface of said core; and
a revolving mechanism for performing a circular motion of said press member along the peripheral surface of said core in synchronism with a rotation of said core until said leading portion of said web makes one revolution around said core and is just about to be wound in a stack condition.

2. A taking-up device according to claim 1, wherein said web is one of a photo film and a photographic paper, said taking-up device being incorporated in a film scanner and a photographic printer to take up said photo film and said photographic paper.

3. A taking-up device according to claim 2, wherein said press member is a nip roller.

4. A taking-up device according to claim 3, further comprising:
a take-up shaft to which said core is fixed; and
a first motor for rotating said take-up shaft.

5. A taking-up device according to claim 4, wherein said revolving mechanism comprises:
an arm rotatably attached to said take-up shaft, said arm rotatably supporting said nip roller; and
a second motor for rotating said arm.

6. A taking-up device according to claim 5, wherein said arm comprises a first arm and a second arm, said first arm is attached to said take-up shaft, and said second arm is rotatably attached to said first arm via a supporting-point shaft, said nip roller being attached to a top end of said second arm.

7. A taking-up device according to claim 6, further comprising:
a moving means for moving said second arm between a first position and a second position, said second arm being folded relative to said first arm in said first position so as to press said nip roller against said core, and said second arm straightening with said first arm in said second position so as to prevent said nip roller from disturbing one of the photo film and the photographic paper to be wound.

8. A taking-up device according to claim 7, wherein said moving means moves said second arm from the first position to the second position after said leading portion of one of the photo film and the photographic paper has made one revolution around said core and has been stacked.

9. A taking-up device according to claim 8, wherein said moving means comprises:
a torsion spring for connecting said second arm and said supporting-point shaft;
a third motor for rotating said supporting-point shaft, said second arm being rotated via said torsion spring when the third motor rotates the supporting-point shaft.

10. A taking-up device according to claim 9, further comprising:
a guide member for guiding said leading portion of one of the photo film and the photographic paper toward said core.

11. A taking-up device according to claim 10, further comprising:
a guide retracting means for keeping said guide member away from one of the photo film and the photographic paper, said guide retracting means evacuating said guide member from one of the photo film and the photographic paper after said leading portion of one of the photo film and the photographic paper has been interposed between said nip roller and said core.

12. A taking-up device according to claim 11, wherein said guide retracting means comprises:
a rack attached to said guide member, a side of said rack being formed with a rack gear extending in a moving direction of said guide member;
a first gear for meshing with said rack gear; and
a fourth motor for driving said first gear.

13. A taking-up device according to claim 12, wherein said arm is formed with an elliptic hole along which said nip roller is moved to nip the leading portion of one of the photo film and the photographic paper.
